(19) United States
(12) Patent Application Publication
(10) Pub. No.: US 2015/0196854 A1
(43) Pub. Date: Jul. 16, 2015

(54) WASTEWATER TREATMENT DEVICE

(71) Applicants: Ming-Hsiang YANG, Hsinchu City (TW); Shang-Shan FAN, Taichung City (TW)

(72) Inventors: Ming-Hsiang YANG, Hsinchu City (TW); Shang-Shan FAN, Taichung City (TW)

(21) Appl. No.: 14/304,461

(22) Filed: Jun. 13, 2014

(30) Foreign Application Priority Data
Jan. 16, 2014 (TW) 103200948

(51) Int. Cl. B01D 1/20; C02F 1/04

(52) U.S. Cl. CPC B01D 1/20; C02F 1/048; C02F 2101/16

(57) ABSTRACT

A wastewater treatment device includes a showering-guided furnace, which comprises a tank, a cyclic heating device and a showering structure. The tank has a water inlet port, a cyclic water inlet port, a cyclic water outlet port, a water outlet port and a gas outlet port. The cyclic heating device is used to draw out the wastewater from the tank, heat the drawn wastewater to a cyclic temperature, and guide the heated wastewater into the tank through the cyclic water inlet port. The showering structure is used to make the wastewater to be formed into a plurality of smaller water flows which are showered. A specific composition of the wastewater is gasified and is drawn out from the tank through the gas outlet port. The above-mentioned wastewater treatment device can save much energy and achieve higher recovery efficiency.

### BACKGROUND OF THE INVENTION

1. Field of the Invention

The present invention relates to a wastewater treatment device, particularly to a wastewater treatment device for separating a specific composition from the wastewater.

2. Description of the Prior Art

Wastewater or waste gas is usually generated in the semiconductor process. To comply with environmental regulations, the wastewater or waste gas can be discharged only when a specific composition of the wastewater or waste gas is reduced under a standard value. For example, ammonia (NH₃) is usually used in the semiconductor processes, such as etch, epitaxial or cleaning, and the unreacted ammonia is discharged from the semiconductor equipment. Therefore, in an ending period of the semiconductor process, the waste gas must be processed, so as to eliminate ammonia from the waste gas or wastewater to comply with environmental regulations.

Conventional treatment methods for the waste gas or wastewater containing ammonia are acid absorption method and combustion method. The acid absorption method uses a sulfuric acid or a phosphoric acid to adsorb the ammonia and the ammonia is converted to an ammonium sulfate solution or an ammonium phosphate solution to be discharged, but the discharge still needs to comply with environmental regulations. The combustion method treats the waste gas with combustion and after combustion, the waste gas is discharged. However, the combustion method leads to higher repair and operation cost. In addition, the above-mentioned method is unable to recover the ammonia for reuse.

To sum up the foregoing descriptions, an objective needed to be achieved now is to provide a wastewater treatment device which can separate a specific composition from the wastewater at lower operation cost.

### SUMMARY OF THE INVENTION

The present invention is directed to provide a wastewater treatment device, which makes the wastewater to be showered in a form of a plurality of smaller water flows with a showering-guided furnace, so as to enhance the gasification efficiency of a specific composition of the wastewater, thus separating the specific composition from the wastewater.

A wastewater treatment device according to one embodiment of the present invention is used for separating a specific composition from a wastewater. The wastewater treatment device comprises a showering-guided furnace, which comprises a tank, a cyclic heating device and a showering structure. The tank has a water inlet port, a cyclic water inlet port, a cyclic water outlet port, a water outlet port and a gas outlet port. The wastewater is guided into the tank through the water inlet port. The cyclic water inlet port and the gas outlet port are disposed at an upper half portion of the tank, and the cyclic water outlet port and the water outlet port are disposed at a lower half portion of the tank. The cyclic heating device is disposed between the cyclic water inlet port and the cyclic water outlet port to draw out the wastewater in the lower half portion of the tank from the tank, heat the drawn wastewater to a cyclic temperature, and guide the heated wastewater into the tank through the cyclic water inlet port. The showering structure is disposed at the upper half portion of the tank and is used to make the wastewater to be formed into a plurality of smaller water flows which are showered. A specific composition of the wastewater is gasified and is drawn out from the tank through the gas outlet port.

An ammonia-contained wastewater treatment device according to another embodiment of the present invention is used for separating ammonia from a wastewater. The ammonia-contained wastewater treatment device comprises a showering-guided furnace, which comprises a tank, a cyclic heating device and a showering structure. The tank has a water inlet port, a cyclic water inlet port, a cyclic water outlet port, a water outlet port and a gas outlet port. The wastewater is guided into the tank through the water inlet port. The cyclic water inlet port and the gas outlet port are disposed at an upper half portion of the tank, and the cyclic water outlet port and the water outlet port are disposed at a lower half portion of the tank. The cyclic heating device is disposed between the cyclic water inlet port and the cyclic water outlet port to draw out the wastewater in the lower half portion of the tank from the tank, heat the drawn wastewater to a cyclic temperature, and guide the heated wastewater into the tank through the cyclic water inlet port. The showering structure is disposed at the upper half portion of the tank and is used to make the wastewater to be formed into a plurality of smaller water flows which are showered. Ammonia of the wastewater is gasified and is drawn out from the tank through the gas outlet port.

Objectives, subject matters, properties and effects achieved of the present invention will become apparent from the following embodiments taken in conjunction with the accompanying drawings.

### BRIEF DESCRIPTION OF THE DRAWINGS

The foregoing aspects and many of the accompanying advantages of this invention will become more readily appreciated as the same becomes better understood by reference to the following detailed descriptions, when taken in conjunction with the accompanying drawings, wherein:

FIG. 1 is a schematic view, schematically illustrating a wastewater treatment device according to one embodiment of the present invention.

### DESCRIPTION OF THE PREFERRED EMBODIMENT

A wastewater treatment device according to one embodiment of the present invention is used for separating a specific composition from a wastewater. For example, the wastewater may be the ammonia-contained wastewater or waste gas generated in the semiconductor processes of the semiconductor industry or the photoelectric industry, but not limited to this. It can be understood that the ammonia-contained wastewater may be formed from the ammonia-contained waste gas by using pure water to adsorb the ammonia. Then, the ammonia may be separated from the wastewater for reuse with the wastewater treatment device of the present invention.

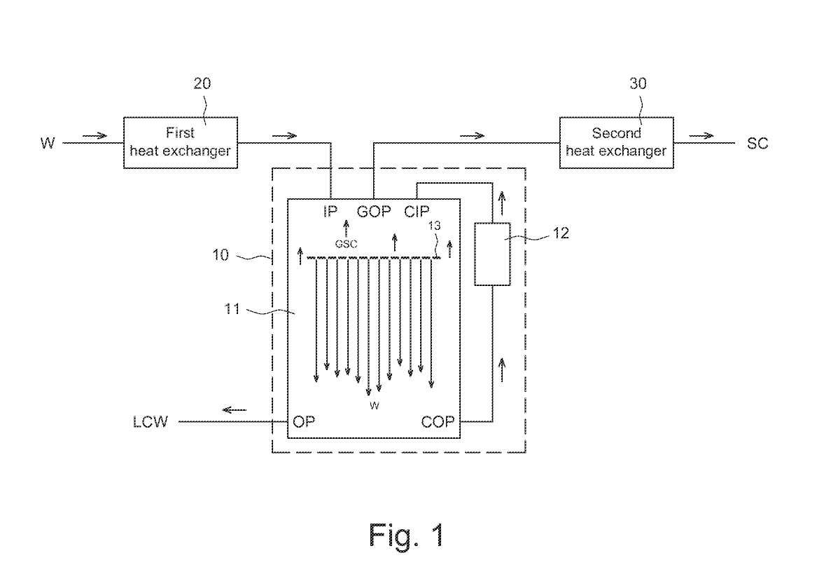

Referring to FIG. 1, the wastewater treatment device according to one embodiment of the present invention comprises a showering-guided furnace 10. The showering-guided furnace 10 comprises a tank 11, a cyclic heating device 12 and a showering structure 13. The tank 11 has a water inlet port IP, a cyclic water inlet port CIP, a cyclic water outlet port COP, a water outlet port OP and a gas outlet port GOP. The wastewater W is guided into the tank 11 through the water inlet port IP. The cyclic water inlet port CIP and the gas outlet port GOP are disposed at an upper half portion of the tank 11, and the cyclic water outlet port COP and the water outlet port OP are disposed at a lower half portion of the tank 11.

The cyclic heating device 12 is disposed between the cyclic water inlet port CIP and the cyclic water outlet port COP. The cyclic heating device 12 can draw out the wastewater W in the lower half portion of the tank 11 from the tank 11 through the cyclic water outlet port COP to heat the drawn wastewater W to a cyclic temperature, and then guide the heated wastewater W into the tank 11 through the cyclic water inlet port CIP. It can be understood that to reduce energy consumption, the tank 11 may comprise a heat-isolating structure (not shown). For example, outer walls of the tank 11 may be a vacuum two-layer structure or capsulated with a foam material, so as to reduce heat energy dissipation. The heat-isolating structure may also be embodied with other existing techniques, which descriptions will be omitted herein. Likewise, pipelines of the cyclic heating device 12 connected to the cyclic water inlet port CIP or the cyclic water outlet port COP may also comprise a suitable heat-isolating structure (not shown).

The showering structure 13 is disposed at the upper half portion of the tank 11. The showering structure 13 may make the wastewater W to be formed into a plurality of smaller water flows which are showered from the upper half portion of the tank, so that a specific composition of the wastewater W is gasified partially and the gaseous specific composition GSC is drawn out from the tank 11 through the gas outlet port GOP.

In one embodiment, the wastewater treatment device according to the present invention further comprises a first heat exchanger 20, which is disposed at an upstream side of the water inlet port IP. The first heat exchanger 20 may be used to adjust the wastewater W to a first temperature. It is noted that the term “adjust” used herein may include a meaning of heating or cooling depending on a design of the real production line.

In one embodiment, the wastewater treatment device according to the present invention further comprises a second heat exchanger 30, which is disposed at a downstream side of the gas outlet port GOP. The second heat exchanger 30 may be used to adjust the specific composition SC vented through the gas outlet port to a second temperature. It is noted that the specific composition SC vented through an outlet port end of the second heat exchanger 30 may be a gas or a liquid, depending on a design of the real production line or requirements of the subsequence process. Likewise, the term “adjust” used herein may include a meaning of heating or cooling.

It is noted that the embodiment shown in FIG. 1 is illustrated with a first heat exchanger, a showering-guided furnace and a second heat exchanger, but is not limited to this. Those skilled in the art may design a wastewater treatment device which can meet real requirements with any number of the above-mentioned elements and different combinations of the above-mentioned elements.

Hereafter, the operation process of the wastewater treatment device according to the present invention is illustrated by processing an ammonia-contained wastewater. First, the ammonia-contained wastewater W is adjusted to a first temperature by the first heat exchanger 20. For example, a temperature range of the first temperature may be from 15 Celsius degree to 99 Celsius degree. It is noted that this process may be omitted and a wastewater having a suitable temperature is directly guided into the tank 11 through the water inlet port IP of the tank 11. The wastewater W guided into the tank 11 through the water inlet port IP may flow into the lower half portion of the tank 11 directly. Preferably, the wastewater W guided into the tank 11 through the water inlet port IP may be formed into a plurality of smaller water flows via the showering structure 13 as well, to be showered from the upper half portion of the tank 11.

Then, the cyclic heating device 12 may draw out the wastewater W in the lower half portion of the tank 11 from the tank 11 through the cyclic water outlet port COP to heat the drawn wastewater W to a cyclic temperature, and guide the heated wastewater W into the tank 11 through the cyclic water inlet port CIP. In one embodiment, a temperature range of the cyclic temperature may be from 25 Celsius degree to 99 Celsius degree. The wastewater guided into the tank 11 through the cyclic water inlet port CIP may be formed into a plurality of smaller water flows via the showering structure 13 to be showered from the upper half portion of the tank 11. It can be understood that when the wastewater having a suitable temperature is showered in a form of a plurality of smaller water flows, a portion of the wastewater will gasify, just like the vapor generated by hot water flowing from a shower nozzle or a watering can when taking a shower. The gasified wastewater may comprise a higher concentration of ammonia. It can be understood that smaller water flows may increase the contact area between the wastewater and air, so as to enhance the efficiency of gasification. The ungasified wastewater may flow into the lower half portion of the tank 11 to undergo next cyclic heating. When a concentration of ammonia of the ungasified wastewater is reduced to a preset value, the lower concentration wastewater LCW may be vented from the tank 11 through the water outlet port OP.

Finally, the gasified wastewater containing a higher concentration of ammonia may be exhausted from the tank 11 through the gas outlet port GOP and adjusted to a second temperature by the second heat exchanger 30. For example, a temperature range of the second temperature may be from −10 Celsius degree to 99 Celsius degree. The second temperature may be determined based on whether a gaseous or liquid product is desired. For example, a higher second temperature should be set if a gaseous product is desired at the outlet port end of the second heat exchanger 30. On the contrary, a lower second temperature should be set if a liquid product is desired. In one embodiment, the product obtained at the outlet port end of the second heat exchanger 30 has a concentration of ammonia more than or equal to 18 wt %.

It is noted that in the above-mentioned embodiment, ammonia is separated from the wastewater, but it is not limited to this. Other specific compositions that may be easily gasified may be separated from the wastewater with the wastewater treatment device according to the present invention.

To sum up the foregoing descriptions, the wastewater treatment device according to the present invention makes the wastewater to be showered in a form of a plurality of smaller water flows with a showering structure in a showering-guided furnace, so that a specific composition of the wastewater may be gasified effectively at a relatively lower cyclic temperature, thus separating the specific composition from the wastewater. Moreover, when the wastewater is showered in a form of a plurality of smaller water flows, the specific composition of the wastewater may be gasified effectively as long as a suitable temperature is sustained. Therefore, when the wastewater is showered, the cyclic temperature of the wastewater may be sustained with less energy in a manner that the liquid wastewater within the tank is drawn out from the tank and cyclically heated, thus saving a lot of energy.

While the invention can be subject to various modifications and alternative forms, a specific example thereof has been shown in the drawings and is herein described in detail. It should be understood, however, that the invention is not to be limited to the particular form disclosed, but on the contrary, the invention is to cover all modifications, equivalents, and alternatives falling within the spirit and scope of the appended claims.

What is claimed is:

1. A wastewater treatment device for separating a specific composition from a wastewater, the wastewater treatment device comprising:
a showering-guided furnace comprising:
a tank having a water inlet port, a cyclic water inlet port, a cyclic water outlet port, a water outlet port and a gas outlet port, wherein the wastewater is guided into the tank through the water inlet port, the cyclic water inlet port and the gas outlet port are disposed at an upper half portion of the tank, and the cyclic water outlet port and the water outlet port are disposed at a lower half portion of the tank;
a cyclic heating device disposed between the cyclic water inlet port and the cyclic water outlet port, to draw out the wastewater in the lower half portion of the tank from the tank, heat the drawn wastewater to a cyclic temperature, and guide the heated wastewater into the tank through the cyclic water inlet port; and
a showering structure disposed at the upper half portion of the tank, to make the wastewater to be formed into a plurality of smaller water flows which are showered, wherein the specific composition of the wastewater is gasified and is drawn out from the tank through the gas outlet port.

2. The wastewater treatment device according to claim 1, wherein a temperature range of the cyclic temperature is from 25 Celsius degree to 99 Celsius degree.

3. The wastewater treatment device according to claim 1, further comprising:
a first heat exchanger disposed at an upstream side of the water inlet port, to adjust the wastewater to a first temperature.

4. The wastewater treatment device according to claim 3, wherein a temperature range of the first temperature is from 15 Celsius degree to 99 Celsius degree.

5. The wastewater treatment device according to claim 1, further comprising:
a second heat exchanger disposed at a downstream side of the gas outlet port, to adjust the specific composition vented through the gas outlet port to a second temperature.

6. The wastewater treatment device according to claim 5, wherein a temperature range of the second temperature is from −10 Celsius degree to 99 Celsius degree.

7. The wastewater treatment device according to claim 5, wherein an outlet port end of the second heat exchanger vents a gas or a liquid of the specific composition.

8. The wastewater treatment device according to claim 1, wherein a concentration of the specific composition separated from the wastewater is more than or equal to 18 wt %.

9. The wastewater treatment device according to claim 1, wherein the tank comprises a heat-isolating structure.

10. The wastewater treatment device according to claim 1, wherein a pipeline of the cyclic heating device connected to the cyclic water inlet port comprises a heat-isolating structure.

11. The wastewater treatment device according to claim 1, wherein a pipeline of the cyclic heating device connected to the cyclic water outlet port comprises a heat-isolating structure.

12. An ammonia-contained wastewater treatment device for separating ammonia from a wastewater, the ammonia-contained wastewater treatment device comprising:
a showering-guided furnace comprising:
a tank having a water inlet port, a cyclic water inlet port, a cyclic water outlet port, a water outlet port and a gas outlet port, wherein the wastewater is guided into the tank through the water inlet port, the cyclic water inlet port and the gas outlet port are disposed at an upper half portion of the tank, and the cyclic water outlet port and the water outlet port are disposed at a lower half portion of the tank;
a cyclic heating device disposed between the cyclic water inlet port and the cyclic water outlet port, to draw out the wastewater in the lower half portion of the tank from the tank, heat the drawn wastewater to a cyclic temperature, and guide the heated wastewater into the tank through the cyclic water inlet port; and
a showering structure disposed at the upper half portion of the tank, to make the wastewater to be formed into a plurality of smaller water flows which are showered, wherein the ammonia of the wastewater is gasified and is drawn out from the tank through the gas outlet port.

13. The ammonia-contained wastewater treatment device according to claim 12, wherein a temperature range of the cyclic temperature is from 25 Celsius degree to 99 Celsius degree.

14. The ammonia-contained wastewater treatment device according to claim 12, further comprising:
a first heat exchanger disposed at an upstream side of the water inlet port, to adjust the wastewater to a first temperature.

15. The ammonia-contained wastewater treatment device according to claim 14, wherein a temperature range of the first temperature is from 15 Celsius degree to 99 Celsius degree.

16. The ammonia-contained wastewater treatment device according to claim 12, further comprising:
a second heat exchanger disposed at a downstream side of the gas outlet port, to adjust the ammonia vented through the gas outlet port to a second temperature.

17. The ammonia-contained wastewater treatment device according to claim 16, wherein a temperature range of the second temperature is from −10 Celsius degree to 99 Celsius degree.

18. The ammonia-contained wastewater treatment device according to claim 16, wherein an outlet port end of the second heat exchanger vents a gaseous ammonia or a liquid ammonia.

19. The ammonia-contained wastewater treatment device according to claim 12, wherein the tank comprises a heat-isolating structure.

20. The ammonia-contained wastewater treatment device according to claim 12, wherein a pipeline of the cyclic heating device connected to the cyclic water inlet port comprises a heat-isolating structure.

21. The ammonia-contained wastewater treatment device according to claim 12, wherein a pipeline of the cyclic heating device connected to the cyclic water outlet port comprises a heat-isolating structure.
